(19) United States
(12) Patent Application Publication
(10) Pub. No.: US 2009/0215469 A1
(43) Pub. Date: Aug. 27, 2009

(54) Device, System, and Method of Generating Location-Based Social Networks

(76) Inventors: Amit Fisher, Nesher (IL); Dagan Gilat, Zichrou Yaakov (IL); Sima Nadler, Kochav Yair (IL); Daniel M. Yellin, Raanana (IL); Gabi Zodik, Nesher (IL)

Correspondence Address: IBM CORPORATION, T.J. WATSON RESEARCH CENTER, P.O. BOX 218, YORKTOWN HEIGHTS, NY, 10598, US

(21) Appl. No.: 12/037,952

(22) Filed: Feb. 27, 2008

(51) Int. Cl. H04Q 7/20

(52) U.S. Cl. 455/456.3

(57) ABSTRACT

Device, system, and method of generating location-based social networks. For example, a method for dynamically creating location-based virtual social networks includes: detecting presence of a wireless device at a location which is associated with a location-based virtual social network; and sending to the wireless device an invitation to join said location-based virtual social network.

### FIELD

Some embodiments are related to the field of electronic communication systems able to provide virtual social network services.

### BACKGROUND

Some electronic communication systems allow users to create or join a virtual community, as well as to engage in virtual social network services. For example, some Internet web-sites (e.g., “MySpace.com” or “Facebook.com”) provide a collection of various ways for users to interact. User interactions include, for example, online chat activities, instant messaging, sharing of photographs and videos, file sharing, writing into a web-log (“blog”) system or reading from a “blog” system, or the like.

In some systems, virtual communities are established among users who share a common interest in a particular topic, for example, users that share a common hobby or profession, or users that are fans of a common singer or sports team. In other systems, virtual communities are established among users who share a common demographic profile, for example, users who are teenagers and reside in California, or users who are university students.

### SUMMARY

Some embodiments include, for example, devices, systems, and methods of generating location-based virtual social networks.

In some embodiments, a method for dynamically creating location-based virtual social networks includes: detecting presence of a wireless device at a location which is associated with a location-based virtual social network; and sending to the wireless device an invitation to join the location-based virtual social network.

In some embodiments, the method includes: adding the wireless device to a group of one or more wireless devices which participate in the location-based virtual social network.

In some embodiments, the method includes: receiving from the wireless device a signal indicating acceptance of the invitation and an identifier of a user of the wireless device; and adding the identifier of the user of the wireless device to a list of one or more participants of the location-based virtual social network.

In some embodiments, the method includes: detecting departure of the wireless device from the location; disassociating the wireless device from the location-based virtual social network; and removing the identifier of the user of the wireless device from the list of participants of the location-based virtual social network.

In some embodiments, the detecting includes: determining whether or not the wireless device is located at the location by one or more detection mechanisms selected from the group consisting of: a cellular triangulation detection mechanism; a Global Positioning System trilateration detection mechanism; a Radio Frequency ID detection mechanism; a Bluetooth wireless signal detection mechanism; an IEEE 802.11 wireless signal detection mechanism; and an IEEE 802.16 wireless signal detection mechanism.

In some embodiments, the method includes: detecting that two or more wireless devices are located within two or more locations of a common type; and sending to at least one of the one or more wireless devices an invitation to join a location-based virtual social network associated with the location type.

In some embodiments, the method includes: sending a location-based advertisement to one or more wireless devices that joined the location-based virtual social network.

In some embodiments, a method for plan-based creation of virtual social networks includes: receiving from a wireless device an indication that a user of the wireless device plans to be within a pre-defined location at a forward time slot; and sending to the user of the wireless device an invitation to join a location-based virtual social network associated with the pre-defined location.

In some embodiments, the sending includes: sending the invitation during the forward time slot upon detection that the wireless device is located within the pre-defined location.

In some embodiments, the method includes: receiving from the wireless device a registration message indicating that the user of the wireless device plans to be within the pre-defined location at the forward time slot.

In some embodiments, the method includes: automatically extracting from a scheduling application of the wireless device information indicating the pre-defined location and information indicating the forward time slot.

In some embodiments, the method includes: automatically extracting location and time information from another scheduling application associated with a device of another user; and matching between the location and time information extracted from the other scheduling application and the location and time information extracted from the wireless device.

In some embodiments, the method includes: automatically terminating at least one service of the location-based virtual social network upon expiration of the forward time slot.

In some embodiments, the method includes: sending a location-based advertisement to one or more wireless devices that joined the location-based virtual social network.

In some embodiments, a system for dynamic creation of location-based virtual social networks includes: one or more detectors to detect presence of a wireless device at a location which is associated with a location-based virtual social network; and an invitation module to send to the wireless device an invitation to join the location-based virtual social network.

In some embodiments, a system for plan-based creation of virtual social networks includes: a registration module to receive from a wireless device an indication that a user of the wireless device plans to be within a pre-defined location at a forward time slot; and an invitation module to send to the user of the wireless device an invitation to join a location-based virtual social network associated with the pre-defined location.

Some embodiments may include, for example, a computer program product including a computer-useable medium including a computer-readable program, wherein the computer-readable program when executed on a computer causes the computer to perform methods in accordance with some embodiments of the invention.

Some embodiments may provide other and/or additional benefits and/or advantages.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1 is a schematic block diagram illustration of a system in accordance with some demonstrative embodiments of the invention.

FIG. 2 is a schematic flow-chart of a method of dynamic creation of location-based virtual social networks in accordance with some demonstrative embodiments of the invention.

FIG. 3 is a schematic flow-chart of a method of plan-based creation of location-based virtual social networks in accordance with some demonstrative embodiments of the invention.

### DETAILED DESCRIPTION

In the following detailed description, numerous specific details are set forth in order to provide a thorough understanding of some embodiments of the invention. However, it will be understood by persons of ordinary skill in the art that embodiments of the invention may be practiced without these specific details. In other instances, well-known methods, procedures, components, units and/or circuits have not been described in detail so as not to obscure the discussion.

Discussions herein utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “plurality” and “a plurality” as used herein includes, for example, “multiple” or “two or more”. For example, “a plurality of items” includes two or more items.

Although portions of the discussion herein relate, for demonstrative purposes, to wired links and/or wired communications, embodiments of the invention are not limited in this regard, and may include one or more wired or wireless links, may utilize one or more components of wireless communication, may utilize one or more methods or protocols of wireless communication, or the like. Some embodiments of the invention may utilize wired communication and/or wireless communication.

Some embodiments of the invention may be used in conjunction with various devices and systems, for example, a Personal Computer (PC), a desktop computer, a mobile computer, a laptop computer, a notebook computer, a tablet computer, a server computer, a handheld computer, a handheld device, a Personal Digital Assistant (PDA) device, a handheld PDA device, an on-board device, an off-board device, a hybrid device (e.g., a device incorporating functionalities of multiple types of devices, for example, PDA functionality and cellular phone functionality), a vehicular device, a non-vehicular device, a mobile or portable device, a non-mobile or non-portable device, a wireless communication station, a wireless communication device, a wireless Access Point (AP), a wireless Base Station, a Mobile Subscriber Station (MSS), a wired or wireless Network Interface Card (NIC), a wired or wireless router, a wired or wireless modem, a wired or wireless network, a Local Area Network (LAN), a Wireless LAN (WLAN), a Metropolitan Area Network (MAN), a Wireless MAN (WMAN), a Wide Area Network (WAN), a Wireless WAN (WWAN), a Personal Area Network (PAN), a Wireless PAN (WPAN), devices and/or networks operating in accordance with existing IEEE 802.11, 802.11a, 802.11b, 802.11g, 802.11n, 802.16, 802.16d, 802.16e, 802.16m standards and/or future versions and/or derivatives and/or Long Term Evolution (LTE) of the above standards, units and/or devices which are part of the above networks, one way and/or two-way radio communication systems, cellular radio-telephone communication systems, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or tag or transponder, a device which utilizes Near-Field Communication (NFC), a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, a wired or wireless handheld device (e.g., BlackBerry, Palm Treo), a Wireless Application Protocol (WAP) device, or the like.

Some embodiments of the invention may be used in conjunction with one or more types of wireless communication signals and/or systems, for example, Radio Frequency (RF), Infra Red (IR), Frequency-Division Multiplexing (FDM), Orthogonal FDM (OFDM), OFDM Access (OFDMA), Time-Division Multiplexing (TDM), Time-Division Multiple Access (TDMA), Extended TDMA (E-TDMA), General Packet Radio Service (GPRS), extended GPRS, Code-Division Multiple Access (CDMA), Wideband CDMA (WCDMA), CDMA 2000, Multi-Carrier Modulation (MDM), Discrete Multi-Tone (DMT), Bluetooth (RTM), Global Positioning System (GPS), IEEE 802.11 (“Wi-Fi”), IEEE 802.16 (“Wi-Max”), ZigBee (TM), Ultra-Wideband (UWB), Global System for Mobile communication (GSM), 2G, 2.5G, 3G, Third Generation Partnership Project (3GPP), 3.5G, or the like. Embodiments of the invention may be used in various other devices, systems and/or networks.

The term “wireless device” as used herein includes, for example, a device capable of wireless communication, a communication device capable of wireless communication, a communication station capable of wireless communication, a desktop computer capable of wireless communication, a mobile phone, a cellular phone, a laptop or notebook computer capable of wireless communication, a PDA capable of wireless communication, a handheld device capable of wireless communication, a portable or non-portable device capable of wireless communication, or the like.

The terms “social network” or “virtual social network” as used herein include, for example, a virtual community, an online community, a community or assembly of online representations corresponding to users of computing devices, a community or assembly of virtual representations corresponding to users of computing devices, a community or assembly of virtual entities (e.g., avatars, usernames, nicknames, or the like) corresponding to users of computing devices, or the like.

In some embodiments, a virtual social network includes at least two users; in other embodiments, a virtual social network includes at least three users. In some embodiments, a virtual social network includes at least one “one-to-many” communication channels or links. In some embodiments, a virtual social network includes at least one communication channel or link that is not a point-to-point communication channel or link. In some embodiments, a virtual social network includes at least one communication channel or link that is not a “one-to-one” communication channel or link.

The terms “social network services” or “virtual social network services” as used herein include, for example, one or more services which may be provided to members or users of a social network, e.g., through the Internet, through wired or wireless communication, through electronic devices, through wireless devices, through a web-site, through a stand-alone application, through a web browser application, or the like. In some embodiments, social network services may include, for example, online chat activities; textual chat; voice chat; video chat; Instant Messaging (IM); non-instant messaging (e.g., in which messages are accumulated into an “inbox” of a recipient user); sharing of photographs and videos; file sharing; writing into a “blog” or forum system; reading from a “blog” or forum system; discussion groups; electronic mail (email); folksonomy activities (e.g., tagging, collaborative tagging, social classification, social tagging, social indexing); forums; message boards; or the like.

The terms “Location-Based” or “LB” as used herein refer to, for example, social network services that are selectively provided based on geographical location or spatial location of one or more users; social network services that are selectively available based on geographical location or spatial location of one or more users; social network services that are selectively provided based on geographical location or spatial location of one or more communication devices; social network services that are selectively available based on geographical location or spatial location of one or more communication devices; social network services that provide content (e.g., through wireless communication) which includes location-specific information, e.g., to mobile users who move or roam geographically among locations; or the like.

At an overview, some embodiments of the invention provide devices, systems, and methods of dynamic and/or planned generation of location-based virtual social networks, as well as providing of location-based virtual social network services.

Some embodiments allow users to create or join a social network based on the spatial location of users, or based on the spatial location of communication devices utilized by users. The spatial location be, for example, a real-world geographical location, e.g., inside the Hilton hotel in Los Angeles; inside the “Circuit City” store in Union Square in New York City; inside Epcot Center in Florida; inside an airplane flying from New York to London; inside a cruise ship sailing from Miami to Cancun; inside the Madison Square Garden sports arena in New York City; or the like. Additionally or alternatively, the spatial location may be a virtual-world virtual location, for example, creating a social network among users that visit a common web-site; or creating a social network among users that visit a common spatial location in a virtual world (e.g., a store or a shopping mall in “Second Life” virtual world). In some embodiments, the spatial location may include a combination of real-world geographical location as well as virtual-world virtual location, for example, creating a social network among all the users who are geographically located in a common airplane flying from Boston to Miami and who are also visiting the web-site “CNN.com”; or creating a social network among users who are located in a real-world (physical) store of “Best Buy” (or in multiple real-world stores of “Best Buy”) and concurrently visit the “BestBuy.com” web-site. In some embodiments, a social network may be dynamically created based on one or more commonalities, or one or more common properties, across multiple locations in which users are located. For example, some embodiments allow dynamic creation of a social network among users that are located within multiple stores of the “Best Buy” chain of stores; or creation of a social network among users that are located in California and within multiple stores of the “Best Buy” chain of stores. Some embodiments allow dynamic creation of a social network among users that are located within multiple stores (optionally, of multiple chains of stores) that sell similar types of products (e.g., computer stores, book stores, or the like), for example, users that are located within any “Best Buy” store or any “Circuit City” store in Manhattan. Some embodiments allow dynamic creation of a social network among users that share a common real-world spatial property and/or virtual-world spatial property; for example, users that are geographically located in Brooklyn, and who currently visit a web-site of a clothing retailer. Other suitable combinations or criteria may be used.

In some embodiments, the social network is dynamically established based on detection of users (or communication devices) that share location properties; for example, some embodiments may detect substantially all users or communication devices that are geographically located within the Hilton hotel in Los Angeles, may create a social network, and may automatically invite such users or devices to join this social network and/or to participate in social network services provided by this social network. In other embodiments, a pre-registration process, or an upfront planning process, may be required prior to establishing the social network, prior to joining the social network, and/or prior to participating in social network services provided by the social network. For example, users that plan to attend a plastics conference at the Hilton hotel in Boston on May 15, 2008, may perform in advance (e.g., days or weeks in advance) a registration process; and the social network may be established on that date only among users that pre-registered in advance and are within the Hilton hotel in Boston. In some embodiments, for example, the pre-planned location-based virtual social network may be operational before the planned event, during the planned event, and/or after the planned event.

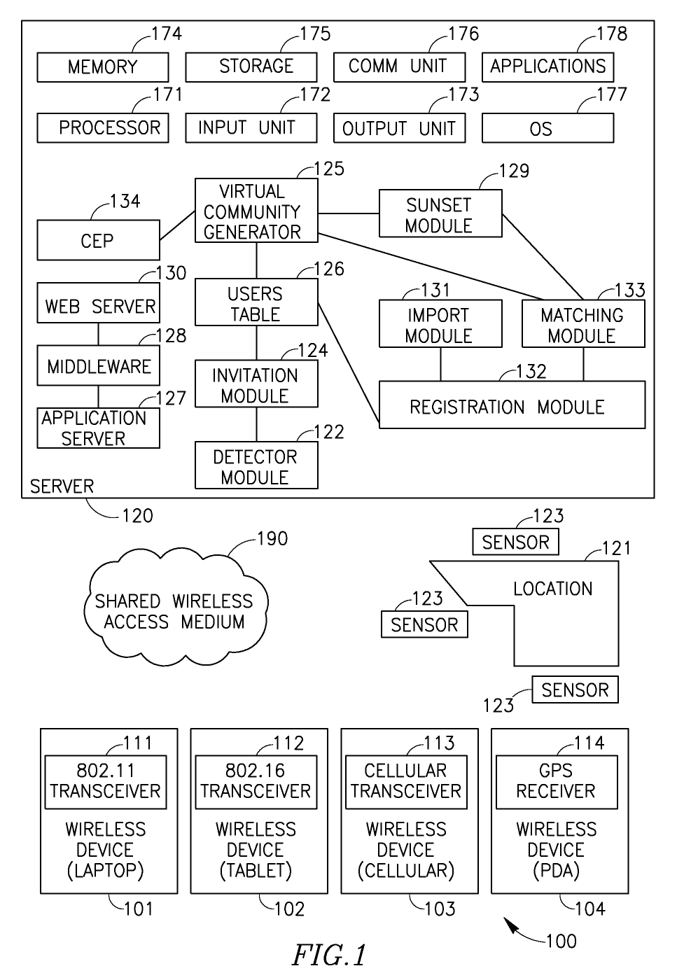

FIG. 1 schematically illustrates a block diagram of a system 100 in accordance with some demonstrative embodiments of the invention. System 100 includes multiple client devices or wireless devices, for example, wireless devices 101-104. Wireless devices 101-104 may be of one or more types; for example, wireless device 101 may be a laptop computer having an IEEE 802.11 transceiver 111; wireless device 102 may be a tablet computer having an IEEE 802.16 transceiver 112; wireless device 103 may be a cellular phone having a cellular transceiver 113; and wireless device 104 may be a PDA device having a GPS receiver 114. Wireless devices 101-104 may me capable of utilizing other types of wireless communications, for example, Bluetooth communication, GPS communication, or the like. Wireless devices 101-104 may be able to communicate wirelessly using a shared wireless access medium 190.

Wireless devices 101-104 may be able to create or join a location-based virtual community or a location-based virtual social network. Although portions of the discussion herein refer, for demonstrative purposes, to creation and/or operation of a location-based virtual social network using client/server architecture, other suitable architectures (e.g., peer-to-peer) may be used.

System 100 optionally includes a server 120 to create and/or operate a location-based virtual social network associated with a location 121. The location 121 may be, for example, a mall, a shopping center, an airport, a sea port, a sports arena, a sports venue, an entertainment venue, a theater, a hall, a museum, an airplane on ground, an airplane in flight, a ship, a yacht, a theme park, an entertainment park, a country club, a sports club, or the like. Optionally, location 121 may include a set of locations having a common property, e.g., multiple stores of a common store chain, multiple stores of multiple store chains that sell a common type of products, or the like.

Server 120 includes, or is associated with, a detector module 122 able to detect that one or more of wireless devices 101-104 is located within the location 121. Optionally, location 121 includes, or is associated with, one or more sensors 123 able to wirelessly sense the presence and/or the location of one or more of devices 101-104. In some embodiments, for example, sensors 123 may include IEEE 802.11 transceivers able to wirelessly sense the presence of, or to detect the location of, the IEEE 802.11 transceiver 111 of wireless device 101. In some embodiments, for example, sensors 123 may include IEEE 802.16 transceivers able to wirelessly sense the presence of, or to detect the location of, the IEEE 802.16 transceiver 112 of wireless device 102. In some embodiments, for example, sensors 123 may include cellular transceivers or cellular base stations able to wirelessly sense the presence of, or to detect the location of, the cellular transceiver 113 of wireless device 103. In some embodiments, for example, sensors 123 may include IEEE 802.16 transceivers able to wirelessly sense the presence of, or to detect the location of, the IEEE 802.16 transceiver 112 of wireless device 102. In some embodiments, the GPS location of the GPS receiver 114 of the PDA 104 is tracked using a GPS server and/or via satellites, and may not require installation of sensors 123 in the location 121 or in proximity thereof. In some embodiments, detector module 122 and/or sensors 123 may utilize one or more methods to determine whether or not a wireless device of devices 101-104 is located within the location 121, for example, using triangulation, trilateration, Bluetooth communication, Radio Frequency (RF) tags or elements, various types of tags or transponders, or the like.

Initially, for example, the detector module 122 may detect that wireless device 101 is located within the location 121. Subsequently, the detector module 122 may detect that wireless device 101 is also located within the location 121. A virtual community generator module 125 may dynamically create a location-based virtual social network, associated with the location 121. An invitation module 124 operates to wirelessly send to the detected wireless devices 101-102 an invitation to join the location-based virtual social network. The users of wireless devices 101-102 may accept the invitation and join the location-based virtual social network; or, may reject the invitation and decline to join the location-based virtual social network. Subsequently, the detector module 122 may detect that wireless device 103 is located within the location 121; and the invitation module 124 operates to wirelessly send to the detected wireless device 103 an invitation to join the location-based virtual social network. Similarly, once the detector module 122 detects that wireless device 104 is located within the location 121, the invitation module 124 operates to wirelessly send to the detected wireless device 104 an invitation to join the location-based virtual social network.

In some embodiments, server 120 optionally utilizes a users table 126 or other list or data base in order to track the status, and the modification in status, of various wireless devices and/or users thereof. For example, the users table 126 may be periodically updated to reflect that a particular wireless device was detected to be within the location 121 starting at a particular date/time stamp; that a particular wireless device was detected to be away from the location 121 starting at a particular date/time stamp; that a particular wireless device is associated with one or more particular types of wireless communication; that an invitation to join the location-based virtual social network was sent to a particular wireless device at a particular date/time stamp; that a signal indicating acceptance or rejection of the invitation was received from the wireless device at a particular date/time stamp; or other suitable information. In some embodiments, partial or full details of wireless devices 101-104 which joined the location-based virtual social network (and/or of users thereof, e.g., name, nickname, or other identifiers or properties) may be visible or accessible to other wireless devices, and/or to an administrator of server 120 or system 100.

In some embodiments, the location-based virtual social network may be established by the virtual community generator 125 upon detection of at least one wireless device within the location 121. In some embodiments, the location-based virtual social network may be established by the virtual community generator 125 upon detection of at least two wireless devices within the location 121. In some embodiments, the location-based virtual social network may be established by the virtual community generator 125 upon detection of at least three wireless devices within the location 121. Other suitable threshold values may be used.

In some embodiments, the location-based virtual social network may be established by the virtual community generator 125 upon reception of at least one acceptance of invitation to participate in the location-based virtual social network. In some embodiments, the location-based virtual social network may be established by the virtual community generator 125 upon reception of at least two acceptances of invitations to participate in the location-based virtual social network. In some embodiments, the location-based virtual social network may be established by the virtual community generator 125 upon reception of at least three acceptances of invitations to participate in the location-based virtual social network. Other suitable threshold values may be used.

In some embodiments, the location-based virtual social network may operate using an application server 127 and/or middleware 128 able to provide social network services to users of wireless devices that participate in the location-based virtual social network. In some embodiments, a web server 130 is utilized to provide social network services to one or more wireless devices (e.g., to wireless device 101 which includes a laptop computer) through the Internet.

In some embodiments, a sunset module 129 may determine to terminate the location-based virtual social network if one or more conditions are met; for example, if less than a pre-defined number of users remain within the location 121; if the network traffic associated with the location-based virtual social network is significantly low; or the like.

In some embodiments, an upfront registration process may be used, in addition to or instead of the dynamic detection of wireless devices 101-104 being within the location 121. For example, the user of wireless device 101 may plan in advance to be within the location 121 during a particular time-window or other forward (e.g., future) time slot (e.g., defined by a beginning date/time stamp and an ending date/time stamp). The user of wireless device 101 may utilize an application of wireless device 101 (e.g., a calendar application, a scheduler application, a tasks manager application, or the like) to store information of his plan. The stored information may be uploaded or submitted from wireless device 101 to the server 120, for example, manually by the user of wireless device 101, or automatically by the scheduling application. Optionally, an import module 131 may be used to convert or re-format information from a first format (e.g., used by the scheduling application) to a second format (e.g., used by the server 120). A registration module 132 may store an indication that the user of wireless device 101 plans to be in the location 121 at the defined time window. Once the time window begins, the invitation module 124 may send to wireless device 101 an invitation to join a location-based virtual social network associated with the location 121. In some embodiments, optionally, the invitation is sent only if the detector module 122 detects that the wireless device 101 is within the location 121, or is in a pre-defined proximity to the location 121. In some embodiments, the invitation is sent substantially immediately following the planning by the user of his future schedule; in other embodiments, the invitation is sent only upon actual arrival of the user to the pre-defined location; in yet other embodiments, the invitation is sent at other suitable times, for example, one day or four hours prior to the commencement of the planned event, or upon detection that the user is located less than one mile of the location of the planned event. Upon acceptance of the invitation, the user is added to the members or participants of the location-based virtual social network associated with the location 121.

In some embodiments, the location-based virtual social network associated with the location 121 may be available to, or accessible by, only users of wireless devices that pre-registered in advance using the registration module 132. In some embodiments, optionally, the location-based virtual social network may be available to, or accessible by, multiple types of users, for example, users of wireless devices that pre-registered in advance; users that did not pre-register in advance but are located within the location 121; or the like. In some embodiments, the location-based virtual social network associated with the location 121 may be available to, or accessible by, users that pre-registered in advance, even if they are not within the location 121 at the pre-defined time window; this may allow, for example, a user that planned to be at a business conference, but could not physically arrive to the location of the business conference, to remotely participate in the location-based virtual social network. In some embodiments, the location-based virtual social network may be available only to users that paid or pre-paid a participation fee or a registration fee, or only to “premium” users that meet pre-defined criteria. In some embodiments, the location-based virtual social network may be available only to the first N users that pre-registered, or to the first N users that arrived to the location 121, or to the first N users that both pre-registered and arrived to the location 121 (wherein N denotes a positive integer); for example, to encourage rapid registration, or to accommodate system requirements for maximum number of users.

In some embodiments, a matching module 133 may be used to determine a common time window to be associated with the location 121 and the operability of the location-based virtual social network. For example, the import module 131 may import from the wireless device 101 data indicating a user's plan to participate in a gaming conference in the Hilton hotel in Boston from May 15 at 08:00 until May 18 at 17:00; may import from the wireless device 102 data indicating a user's plan to participate in a gaming conference in the Hilton hotel in Boston from May 15 at 09:00 until May 18 at 17:30; and may import from the wireless device 101 data indicating a user's plan to participate in a gaming conference in the Hilton hotel in Boston from May 16 at 10:00 until May 18 at 17:15. In some embodiments, the matching module 133 may determine a time window based on intersect of time windows (e.g., from May 15 at 08:00 until May 18 at 17:30). In other embodiments, the matching module 133 may determine a time window based on intersect of time windows (e.g., from May 16 at 10:00 until May 18 at 14:30). In still other embodiments, the matching module 133 may utilize averaging techniques, or calculations taking into account the most common time portions in which multiple plans overlap. In yet other embodiments, the matching module may add “safety margins” before the time window begins, and/or after the time window ends, such that the location-based virtual social network to some early users as well as to some users who stay overtime. In some embodiments, the sunset module 129 may be associated with the registration module 132 and/or the matching module 133, and may determine to terminate the location-based virtual social network based on the imported registration information as matched by the matching module 133. Other suitable criteria may be used.

In some embodiments, system 100 allows dynamic creation of a location-based online community of users, or location-based virtual social networks. For example, location-based virtual social network are dynamically created “on demand” or “on the fly”, based on the physical location of users of wireless devices and their willingness to participate in such location-based virtual social networks. When a user enters a physical location in which such location-based virtual social network exists, the user is promoted with an invitation to join that location-based virtual social network. In some embodiments, individual users are able to initiate the dynamic creation of new location-based virtual social networks based on their geographic location. Once a user leaves the physical location, the user is subtracted from that location-based virtual social network, either by omitting him entirely from the location-based virtual social network with no option to form any social activity, or by informing the community members that although this member is still active, he is no longer located within the geographical location boundaries of the location-based virtual social network. This may result in a dynamic community that reflects the actual participants within the geographical location boundaries at substantially any point in time.

In some embodiments, optionally, a location-based virtual social network may allow to add new members even if they were not part of the dynamic creation of the location-based virtual social network, as long as historically these members visited the geographic location of that community (e.g., a location-based virtual social network of persons who visited a particular museum at least once in the last year). Optionally, the location-based virtual social network may further be associated with a context (e.g., a conference, basketball game, or the like), such that the location-based virtual social network expires or “vanishes” once the context expires or becomes invalid.

In some embodiments, users may manage their participation in location-based virtual social networks by utilizing a profile. For example, the user may select a profile option of “do not disturb me under any circumstances” in order to automatically reject all invitations to join location-based virtual social networks; or a profile option of “join only within a specified geographic location” or “join only din morning time”. Other suitable conditions may be used.

In some embodiments, users may be allowed to join a location-based virtual social network even if they are not in the specified physical location 121, nor plan to be. The location-based virtual social network may “mark” these members and may limit their social network services (e.g., read-only mode, or limited number of postings). The location-based virtual social network may further allow location-based service providers to communicate with, and to provide customized services to, the community of users that joined the location-based virtual social network; and may allow members of the location-based virtual social network to become aware once a new service provider enters the location-based virtual social network to provide new services.

In some embodiments, the user may opt into the on-demand location-based virtual social network in its entirety, may selectively opt to participate in one or more subsets of the location-based virtual social network. For example, the user may select a subset based on age, gender, or other properties. The user may further select a subset that includes users that are both in the ad-hoc location-based virtual social network and also part of his “general” (e.g., non-location-based) virtual social network. Other parameters may be used for selecting a subset.

In some embodiments, location-based virtual social networks may be merged or split. For example, two or more location-based virtual social networks communities may be joined or merged if they are associated with numerous common properties. Similarly, a location-based virtual social network may split into two or more to sub-communities, for example, if the original location-based virtual social network is associated with different interests that can be split among the sub-communities. In some embodiments, groups or sub-groups of location-based virtual social networks may be created. In some embodiments, a location-based virtual social network may be created out of two or more sub-networks; for example, a merged location-based virtual social network may be created to join users of a first location-based virtual social network (e.g., users located in a football stadium watching a football game) with users of a second location-based virtual social network (e.g., users located in a sports bar watching a broadcast of the same football game).

In some embodiments, system 100 allows creation of location-based virtual social networks based on upfront planning. Accordingly, social interaction is created and performed based on upfront planning of the future physical location of multiple users. While utilizing their planning tools (e.g., calendars, to-do lists, emails, or the like), the users are alerted when “related” participants plan to be at a similar (or identical) physical location at the same time (or during a partially overlapping time period). This alert allows the user to create and/or join this location-based virtual social network, for example, from the present until the point in time when the participants are located within the same location. The related individuals may be, for example, any entity from the user's general virtual social network; users with similar habits and past experience; users sharing a common pre-configured interest; or the like. Optionally, this location-based virtual social network may further be the basis for dynamic “on demand” communities or members, as new members may be allowed to dynamically join this location-based virtual social network when they enter the geographical location boundaries.

In some embodiments, a location-based virtual social network may be created based on locations that users visited in the past. For example, users may find the intersections of their geographical locations within a specified historical time, and may create a location-based virtual social network associated with other users who attended that physical location in the past, or during a defined time window in the past (e.g., a location-based virtual social network of users who visited a particular museum in the past, or in the last three years).

For demonstrative purpose, some non-limiting examples are discussed herein to demonstrate the functionality and the operation of system 100; other suitable operations or sets of operations may be performed or facilitated using system 100.

In some demonstrative embodiments, a location-based virtual social network is dynamically created. For example, in a first demonstrative example, a user is taking a long-distance or short-distance flight. While the user is within the airplane (e.g., before takeoff, during actual flight, and/or after takeoff), the user utilizes his PDA device and receives a message to join an on-demand location-based virtual social network that includes, for example, some or all of the users of wireless devices that are on that airplane. The user accepts the invitation, and is also able to see names or nicknames of all the other users who accept a similar invitation. Some users may utilize their PDA devices, laptop computers, or cellular phones, whereas other users may utilizes special (wireless and/or wired) devices that are located within the airplane (e.g., attached or associated with individual seats). The users may utilize community-based features and activities, for example, chat rooms that relate to their common interest, e.g., to discuss ride from the airport to a nearby city center, to recommended or inquire about hotels and restaurants in their common destination, or the like. Optionally, the location-based virtual social network is utilized as an advertising channel (e.g., by an operator of the location-based virtual social network, by the flight carrier, or by third parties), to provide advertisements, promotions, and tailored or customized advertisement which may target this particular audience (e.g., to advertise a tourist attraction in the destination location). Similarly, system 100 may be utilized in conjunction with train rides, subway rides, boat cruises, or other suitable transportation carriers.

In another demonstrative example, a user travels for a business conference to be held at a particular hotel in Boston. When the user enters the conference hotel, the user receives, through his wireless device, a SMS message which invites the user to join a location-based virtual social network dedicated for this business conference. The user accepts the invitation, joins the location-based virtual social network, and open its public chat room, in which the user finds out that two of her university classmates are attending the same business conference. The user then opens a private chat room with these two users, and they chat in private and decide to meet for dinner. The user further utilizes the location-based virtual social network to chat with a local restaurant provider, to find out that the restaurant is able to customize a meal to accommodate her particular diet, and to make reservations for the dinner at the restaurant. Optionally, once the business conference terminates, the location-based virtual social network expires and is no longer available.

In yet another demonstrative example, a family is entering a theme park or an amusement park. While waiting in line for an attraction or activity, one or more family members may utilize devices (e.g., wireless devices of the family members, and/or special devices fixed within the waiting line) in order to join a location-based virtual social network. For example, the location-based virtual social network includes all the park visitors for that day, or for that week; or all the park visitors that showed interest in this particular attraction or activity. The users may use the location-based virtual social network to exchange ideas and recommendations on different attractions and activities (e.g., rides), to exchange waiting time estimations, to inquire about dining possibilities and recommendations, to rate attractions and activities, or the like.

In still another demonstrative example, a spectator in a sports game or in a sports arena utilizes a wireless device to join a location-based virtual social network associated with the particular sports game being played. The spectator may utilize his wireless device to wirelessly order food and drink items, to be delivered directly to his seat, and may optionally pay wirelessly using his credit card details or other suitable payment methods. Optionally, a first spectator utilizes his wireless device to join the location-based virtual social network, and advertises that he has two tickets that he cannot use for next week's game; a second spectator utilizes her wireless device to join the location-based virtual social network, to read the advertised information, and to schedule a meeting with the seller during the break in order to purchase from him the two tickets.

Optionally, a first location-based virtual social network may be created by, and joined by, users or spectators that are fans of a first sports team; whereas a second location-based virtual social network may be created by, and joined by, users or spectators that are fans of a second sports team (e.g., the first sports team plays against the second sports team in the sports arena). The two (or more) location-based virtual social network may co-exist and may operate separately within the spatial area of the same sports arena.

In some embodiments, a user of a wireless device is required (e.g., due to personal reasons) to be outside the sporting arena during the first half of the sports game; he utilizes his wireless device to join a location-based virtual social network associated with this particular sports event, optionally in a “listening mode” or a “quiet mode” (e.g., allowing him to silently receive read chat content, messages, and other content). Based on his participation in the location-based virtual social network during the first half of the sports game, the user may decide whether or not to physically attend the second half of the sports game.

In another demonstrative example, a user of a wireless device enters a “Best Buy” store in Brooklyn, N.Y., in order to purchase a gaming console. The user may utilize his wireless device in order to join one or more location-based virtual social networks, for example, a location-based virtual social network of shoppers in this particular branch of “Best Buy”; a location-based virtual social network of both shoppers and employees of this particular branch of “Best Buy”; a location-based virtual social network of shoppers who are interested in gaming consoles; a location-based virtual social network of shoppers who are interested in a particular type or model of gaming console; a location-based virtual social network of shoppers that are located in different branches of the “Best Buy” store, e.g., in Brooklyn, or in New York State, or a subset of such shoppers who are interested in gaming consoles, or in a particular type or model of gaming console.

In yet another demonstrative example, a user is browsing an Internet web-site (e.g., CNN.com) and is able to join a location-based (virtual-location based) virtual social network of users that are visiting (or visited) the same web-site, or are visiting (or visited) the same web-page, or are visiting (or visited) the same section of the web-site; or are visiting two or more web-sites of a common type (e.g., news web-sites). The location-based virtual social network allows such user to discuss news items, to share ideas and arguments, or the like.

In some demonstrative embodiments, a location-based virtual social network is created based on upfront planning and/or historic information. For example, in a demonstrative example, a user plans to attend a business conference in Miami, Fla. The user utilizes a wireless device or a wired computing device (e.g., a desktop computer) to indicate, in a scheduling or calendar application, that the user intends to be in Miami for three particular days of the subsequent month. Optionally, the information may be registered using the registration module 132, and may be matched by the matching module 133 with information of other users. Accordingly, the user may receive an automatic alert from system 100 to his wireless device, indicating that a first friend of the user plans to attend the same conference during an overlapping time window; and that a second friend of the user plans to be in Miami, for other purposes, during a time window that partially overlaps with the business conference time window. The user may create or join a location-based virtual social network, and may configure it to automatically expire upon termination of the business conference. The user then sends to his friend(s) messages inviting them to join the location-based virtual social network; upon their joining, they may chat, exchange messages, and schedule a meeting time and a meeting venue. In the subsequent month, the user travels to Miami and enters the lobby of the hotel in which the business conference is held. The user logs into the location-based virtual social network that he created in advance; receives an indication that the first friend already arrived to the same location and is already logged-in; receives an indication that the second friend did not yet arrive to the location, and/or did not yet log in; and optionally finds out that other users joined (e.g., dynamically or after pre-registration) the location-based virtual social network. The user may receive on his wireless device a message from one or more other users of the location-based virtual social network, inviting the user to meet at a particular time and place; upon acceptance of such invitations, the calendar or scheduling application of the wireless device may be automatically updated.

In another demonstrative example, twenty people attended a car racing school for one week in Daytona Beach, Fla. During their visit at the school, they participated in a location-based virtual social network, by joining it dynamically or after a pre-registration process. Some or all of the group members determine to keep in touch after this week ends, in order to further exchange information about car racing or other topics, and in order to coordinate subsequent sessions or meetings. The location-based virtual social network may thus be maintained and continue to operate among these members, even after the week at the school ends. Optionally, the location-based virtual social network may be merged into an ongoing virtual social network (e.g., not necessarily location-based) in the same field of interest.

In some embodiments, a location-based virtual social network may support or include location-based advertising, location-based promotions (e.g., discounts, coupons, special offers, or the like), and other location-based commercial services. For example, the Hilton Hotel may selectively offer location-based advertisements, promotions and/or advertisements to some or all users of wireless devices that participate in a dynamic location-based virtual social network that forms on the hotel's premises. Similarly the “Best Buy” store, or chain of stores, may offer location-based advertisements, promotions and/or commercial services to any virtual social network formed by consumers browsing or “surfing” its web-pages. These advertisements, promotions and/or commercial services may be specific to the particular location-based virtual social network; or may be offered to any virtual social network related to that location. In some embodiments, users who join the virtual community may be able to permit or disable (e.g., using opt-in or opt-out mechanisms) such advertisements, promotions and/or commercial services being offered. In some embodiments, commercial establishments or entities may receive invitations to join a dynamic location-based virtual social network, for example, if such commercial entities may offer special promotions or discounts to the members of the location-based virtual social network. For example, the participants in a location-based virtual social network of students attending the car racing school in Daytona Beach, Fla., may invite car racing manufacturers (e.g., not necessarily on the premises) to advertise on this location-based virtual social network if such manufacturers agree to offer discount on purchases performed during the week of the course.

In some embodiments, a particular member of the group did not bring a wireless device to the car racing school; or did not use his wireless device in order to join (e.g., dynamically or after pre-registration) during the week at the car racing school. Two months after the week at the car racing school, the user may utilize a wireless device or a wired device (e.g., a desktop computer) to join the location-based virtual social network which is still operational. The user may thus utilize the location-based virtual social network to exchange information with other group members, although the user did not originally participate in the location-based virtual social network in real-time at the location.

In some embodiments, system 100 may utilize IEEE 802.11 communication, IEEE 802.16 communication, WAN communication, cellular communication, and/or other suitable infrastructure for creation and/or operation of location-based virtual social networks. In some embodiments, multiple communication standards or protocols may be used to support a common location-based virtual social network. For example, system 100 may locate or estimate the physical location of participants in the location-based virtual social network or of candidates to join the location-based virtual social network. Optionally, the Internet or the World Wide Web may be used as a platform, utilizing an additional layer of location identification. Some embodiments may utilize devices fixed within a geo-spatial location (e.g., devices provided in an airplane or in an amusement park) as gateway to the location-based virtual social network.

In some embodiments, the application server 127 and/or middleware 128 may support various community features and location-based virtual social network services (e.g., forums, messages, talkbacks, chats, tagging, rating, or the like). The application server 127 and/or middleware 128 may support identification of newcomers to the geographical location; dynamic creation of location-based virtual social networks; dynamic invitation to join location-based virtual social networks; and automatic sunset of location-based virtual social networks based on temporal and/or context conditions or criteria.

Some embodiments may utilize a client/server architecture, a centralized architecture, a Peer-to-Peer (P2P) architecture, a distributed architecture, or other suitable architectures or combinations thereof. In some embodiments, a publisher/subscriber architecture may be used, for example, for various topics, optionally in conjunction with scalable P2P infrastructure.

For example, some embodiments may be implemented using fully distributed architecture, semi or partially distributed architecture, Peer to Peer (P2P) architecture, or the like. Users may connected to one or more P2P hubs, which need store data or implementation logic, and may operate as a |first link” into the P2P network. Through the P2P hubs, users may be able to reach other users who connected to the same P2P network. For example, a user may create a location (e.g., similar to location 121) and allow its sharing with other users. The location profile may be, for example, a current location or a future location extracted from the user's calendar, “to do” list, or other planning tools or scheduling tools. Furthermore, users may share their profile if they select to connect to a location-based context-based social network. Once the user establishes both the connectivity to the P2P network and the sharing of one or more location profiles, users may create a new virtual social network based on location and/or context profile, and may send invitations through the virtual social network to users who fall under the social network specification (e.g., using components similar to the import module 131 and/or matching module 133); and the invitees may accept the invitation and join the virtual social network. The invitation process may be performed in a reactive mode, in which the user is actively open and invites users to join a virtual social network; and/or in a proactive mode, in which “agents” or “crawlers” are crawling the P2P network and search for possible matching among users who connected to the P2P network and shared their location profiles. Similarly, a sunset or termination process of the P2P location-based virtual social network may be performed based on reactive or proactive modes, or based on other suitable criteria (e.g., similar to sunset module 129). In some embodiments, the P2P network may be further utilized in order to provide the social network services of the location-based virtual social network (e.g., file sharing, chat sessions, or the like).

In some embodiments, presence zones may be defined and utilized by system 100 in order to automatically determine the context of a geo-spatial location, thereby allowing creation of location-based virtual social networks with common contexts across multiple geographical locations. Optionally, the middleware 128 may include a presence server able to determine that a wireless device is located within (or away from) a pre-defined location, and optionally having context-based information associated with the location. In some embodiments, Complex Event Processing (CEP) may be used, for example, by a CEP engine 134, to detect “situations” of interest (e.g., based on filtering or analysis of multiple events) for creation of location-based virtual social networks based on detection of complex patterns, correlation and abstraction, hierarchies, and relationships (e.g., causality, membership, timing, or the like).

In some embodiments, planning tools and planning applications (e.g., calendars, to-do lists, email clients, scheduling applications, or the like) may be adapted, upgraded, updated or augmented (e.g., using a plug-in or other extension) to support upfront planning of future participation in location-based virtual social networks, to support location awareness, and to allow extraction of location and/or time-and-date from user plans. For example, the matching module 133 may match among different location and time-and-date information objects derived from planning tools of users, optionally taking into account their social network and group of interest. Accordingly, the application server 127 and/or middleware 128 may support creation of a location-based virtual social network that continue to operate within the physical location at the specified point in time, optionally with automatic expiration based on temporal criteria. In some embodiments, static means and/or machine learning may be used for upfront planning of location-based virtual social networks.

Some embodiments provide a method for creation of social networks, based on geographical location of individual users. The geographic location may refer to location in the real world, location in a virtual world, or a combination thereof. Optionally, a virtual community may be created based on commonalities across multiple locations, for example, a social network for all users located on one of the stores from a specified store chain in a specified city; or for users who are located in stores that sell similar products.

In some embodiments, the location-based virtual social networks may be created in various methods, for example, dynamically or as part of an upfront planning process. The dynamic creation is performed on demand, based on physical location of users and their willingness to participate in such communities. The creation based on upfront planning and history utilizes upfront planning of the future physical location of the members of the location-based virtual social network; for example, while using their planning tools (e.g. calendars, to-do lists, email applications, or the like), users may be alerted when related participants also plan to be at a similar (or the same) physical location at the same time (or during an at least partially-overlapping time window).

Some embodiments allow creation of a location-based virtual social network among users that are located within a real-life geo-spatial location (e.g., a real-life mall or shopping center), and not necessarily among users that commonly utilize a virtual location (e.g., among users that visit a virtual mall on the Internet). In some embodiments, the location-based virtual social network may be created among users of a virtual location, or among a subset of users that visit a specific “location” within a virtual world (e.g., a subset of users of the Second Life virtual world who virtually visit a particular “location” within the Second Life virtual world). Some embodiments allow association between members of the location-based virtual social network.

In some embodiments, server 120 may be implemented using suitable hardware components and/or software components, for example, a processor 171, an input unit 172, an output unit 173, a memory unit 174, a storage unit 175, and a communication unit 176.

Processor 171 includes, for example, a Central Processing Unit (CPU), a Digital Signal Processor (DSP), one or more processor cores, a single-core processor, a dual-core processor, a multiple-core processor, a microprocessor, a host processor, a controller, a plurality of processors or controllers, a chip, a microchip, one or more circuits, circuitry, a logic unit, an Integrated Circuit (IC), an Application-Specific IC (ASIC), or other suitable multi-purpose or specific processor or controller. Processor 171 executes instructions, for example, of an Operating System (OS) 177 or of one or more applications 178.

Input unit 172 includes, for example, a keyboard, a keypad, a mouse, a touch-pad, a joystick, a track-ball, a stylus, a microphone, or other suitable pointing unit or input device. Output unit 173 includes, for example, a monitor, a screen, a Cathode Ray Tube (CRT) display unit, a Liquid Crystal Display (LCD) display unit, a plasma display unit, one or more audio speakers or earphones, or other suitable output devices.

Memory unit 174 includes, for example, a Random Access Memory (RAM), a Read Only Memory (ROM), a Dynamic RAM (DRAM), a Synchronous DRAM (SD-RAM), a flash memory, a volatile memory, a non-volatile memory, a cache memory, a buffer, a short term memory unit, a long term memory unit, or other suitable memory units. Storage unit 175 includes, for example, a hard disk drive, a floppy disk drive, a Compact Disk (CD) drive, a CD-ROM drive, a Digital Versatile Disk (DVD) drive, an internal or external database or repository, or other suitable removable or non-removable storage units. Memory unit 174 and/or storage unit 175, for example, store data processed by server 120.

Communication unit 176 includes, for example, a wired or wireless transceiver, a wired or wireless modem, a wired or wireless Network Interface Card (NIC), or other unit suitable for transmitting and/or receiving communication signals, blocks, frames, transmission streams, packets, messages and/or data. Optionally, communication unit 176 includes, or is associated with, one or more antennas.

In some embodiments, some or all of the components of server 120 are enclosed in a common housing or packaging, and are interconnected or operably associated using one or more wired or wireless links. In other embodiments, components of server 120 are distributed among multiple or separate devices or locations.

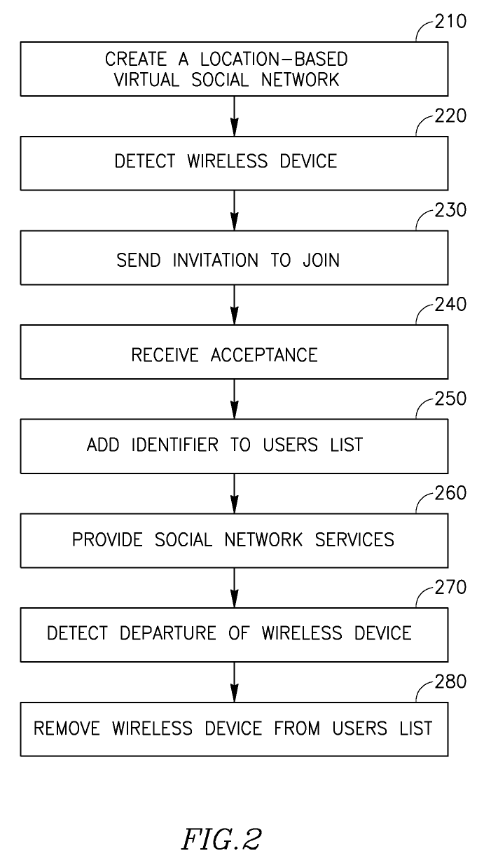

FIG. 2 is schematic flow-chart of a method of dynamic creation of location-based virtual social networks in accordance with some demonstrative embodiments of the invention. Operations of the method may be used, for example, by system 100 of FIG. 1, and/or by other suitable units, devices and/or systems.

In some embodiments, the method may include, for example, creating a location-based virtual social network associated with a pre-defined location (block 210).

In some embodiments, the method may include, for example, detecting that a wireless device is located within the pre-defined location (block 220).

In some embodiments, the method may include, for example, sending to the wireless device an invitation to join the location-based virtual social network associated with the pre-defined location (block 230).

In some embodiments, the method may include, for example, receiving from the wireless device an indication of acceptance of the invitation (block 240).

In some embodiments, the method may include, for example, adding an identifier of the user of the wireless device (e.g., a name, a nickname, a username, or the like) to a list of users participating in the location-based virtual social network (block 250).

In some embodiments, the method may include, for example, providing location-based virtual social network services to the participants of the location-based virtual social network (block 260).

In some embodiments, the method may include, for example, detecting that a wireless device is no longer within the pre-defined location (block 270), for example, if the user of the wireless device departed from or exited the pre-defined location; and in response, optionally, removing or subtracting the departed wireless device from the list of participants in the location-based virtual social network (block 280).

Other suitable operations or sets of operations may be used in accordance with embodiments of the invention.

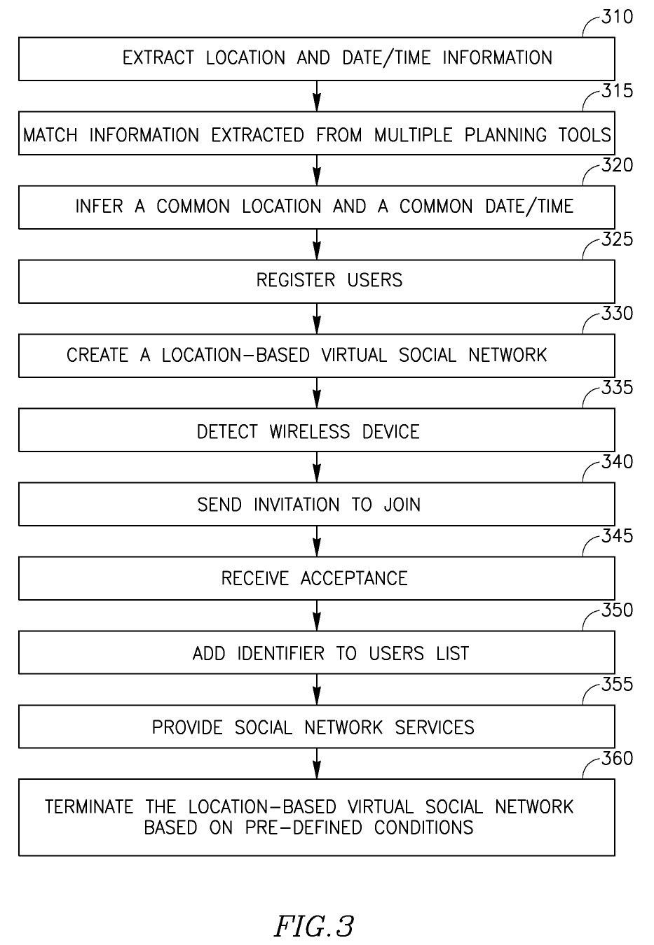

FIG. 3 is schematic flow-chart of a method of plan-based creation of location-based virtual social networks in accordance with some demonstrative embodiments of the invention. Operations of the method may be used, for example, by system 100 of FIG. 1, and/or by other suitable units, devices and/or systems.

In some embodiments, the method may include, for example, extracting location information and date/time information from a planning tool of a computing device (block 310).

In some embodiments, the method may include, for example, matching among location information and date/time information extracted from planning tools of multiple computing device (block 315).

In some embodiments, the method may include, for example, inferring a common location which two or more users of the computing devices plan to attend in a common forward (e.g., future) time/date (block 320), or otherwise inferring a common event that multiple users plan to attend. This may optionally include, for example, inferring a location type of a property common to multiple locations, e.g., inferring that multiple users plan to visit multiple branches of “Best Buy” stores, or the like.

In some embodiments, the method may include, for example, registering one or more of the users for future participation in a location-based virtual social network associated with the common location and the common time/date (block 325).

In some embodiments, the method may include, for example, creating a location-based virtual social network associated with the location (block 330), and optionally associated with the determined time/date. The creation may be performed, for example, a pre-defined time period (e.g., two hours, one day, or the like) prior to the planned commencement of the scheduled event.

In some embodiments, the method may include, for example, detecting that a registered wireless device is within the pre-defined location (block 335).

In some embodiments, the method may include, for example, sending to the registered wireless device an invitation to join the location-based virtual social network associated with the location (block 340). In some embodiments, invitations are exclusively sent to pre-registered users; in other embodiments, invitations are sent to substantially all users of wireless devices that are within the location.

In some embodiments, the method may include, for example, receiving from the pre-registered wireless device an indication of acceptance of the invitation (block 345).

In some embodiments, the method may include, for example, adding an identifier of the user of the wireless device (e.g., a name, a nickname, a username, or the like) to a list of users participating in the location-based virtual social network (block 350).

In some embodiments, the method may include, for example, providing location-based virtual social network services to the participants of the location-based virtual social network (block 355).

In some embodiments, the method may include, for example, terminating the location-based virtual social network (or terminating the accessibility to the location-based virtual social network, or terminating one or more services of the location-based virtual social network) based on pre-defined conditions or criteria, e.g., upon expiration of the time/date slot (block 360).

Other suitable operations or sets of operations may be used in accordance with embodiments of the invention.

Some embodiments of the invention, for example, may take the form of an entirely hardware embodiment, an entirely software embodiment, or an embodiment including both hardware and software elements. Some embodiments may be implemented in software, which includes but is not limited to firmware, resident software, microcode, or the like.

Furthermore, some embodiments of the invention may take the form of a computer program product accessible from a computer-usable or computer-readable medium providing program code for use by or in connection with a computer or any instruction execution system. For example, a computer-usable or computer-readable medium may be or may include any apparatus that can contain, store, communicate, propagate, or transport the program for use by or in connection with the instruction execution system, apparatus, or device.

In some embodiments, the medium may be an electronic, magnetic, optical, electromagnetic, infrared, or semiconductor system (or apparatus or device) or a propagation medium. Some demonstrative examples of a computer-readable medium may include a semiconductor or solid state memory, magnetic tape, a removable computer diskette, a random access memory (RAM), a read-only memory (ROM), a rigid magnetic disk, and an optical disk. Some demonstrative examples of optical disks include compact disk—read only memory (CD-ROM), compact disk—read/write (CD-R/W), and DVD.

In some embodiments, a data processing system suitable for storing and/or executing program code may include at least one processor coupled directly or indirectly to memory elements, for example, through a system bus. The memory elements may include, for example, local memory employed during actual execution of the program code, bulk storage, and cache memories which may provide temporary storage of at least some program code in order to reduce the number of times code must be retrieved from bulk storage during execution.

In some embodiments, input/output or I/O devices (including but not limited to keyboards, displays, pointing devices, etc.) may be coupled to the system either directly or through intervening I/O controllers. In some embodiments, network adapters may be coupled to the system to enable the data processing system to become coupled to other data processing systems or remote printers or storage devices, for example, through intervening private or public networks. In some embodiments, modems, cable modems and Ethernet cards are demonstrative examples of types of network adapters. Other suitable components may be used.

Functions, operations, components and/or features described herein with reference to one or more embodiments, may be combined with, or may be utilized in combination with, one or more other functions, operations, components and/or features described herein with reference to one or more other embodiments, or vice versa.

While certain features of some embodiments of the invention have been illustrated and described herein, many modifications, substitutions, changes, and equivalents may occur to those skilled in the art. It is, therefore, to be understood that the appended claims are intended to cover all such modifications and changes.

What is claimed is:

1. A method for dynamically creating location-based virtual social networks, the method comprising:
detecting presence of a wireless device at a location which is associated with a location-based virtual social network; and
sending to the wireless device an invitation to join said location-based virtual social network.

2. The method of claim 1, comprising:
adding the wireless device to a group of one or more wireless devices which participate in the location-based virtual social network.

3. The method of claim 1, comprising:
receiving from the wireless device a signal indicating acceptance of the invitation and an identifier of a user of the wireless device; and
adding the identifier of the user of the wireless device to a list of one or more participants of the location-based virtual social network.

4. The method of claim 3, comprising:
detecting departure of the wireless device from said location;
disassociating the wireless device from the location-based virtual social network; and
removing the identifier of the user of the wireless device from the list of participants of the location-based virtual social network.

5. The method of claim 1, wherein detecting comprises:
determining whether or not the wireless device is located at said location by one or more detection mechanisms selected from the group consisting of:
a cellular triangulation detection mechanism;
a Global Positioning System trilateration detection mechanism;
a Radio Frequency ID detection mechanism;
a Bluetooth wireless signal detection mechanism;
an IEEE 802.11 wireless signal detection mechanism; and
an IEEE 802.16 wireless signal detection mechanism.

6. The method of claim 1, comprising:
detecting that two or more wireless devices are located within two or more locations of a common type; and
sending to at least one of the one or more wireless devices an invitation to join a location-based virtual social network associated with said location type.

7. The method of claim 1, comprising:
sending a location-based advertisement to one or more wireless devices that joined the location-based virtual social network.

8. A method for plan-based creation of virtual social networks, the method comprising:
receiving from a wireless device an indication that a user of the wireless device plans to be within a pre-defined location at a forward time slot; and
sending to the user of the wireless device an invitation to join a location-based virtual social network associated with said pre-defined location.

9. The method of claim 8, wherein the sending comprises:
sending the invitation during the forward time slot upon detection that the wireless device is located within the pre-defined location.

10. The method of claim 8, comprising:
receiving from the wireless device a registration message indicating that the user of the wireless device plans to be within the pre-defined location at the forward time slot.

11. The method of claim 8, comprising:
automatically extracting from a scheduling application of the wireless device information indicating the pre-defined location and information indicating the forward time slot.

12. The method of claim 11, comprising:
automatically extracting location and time information from another scheduling application associated with a device of another user; and
matching between the location and time information extracted from the other scheduling application and the location and time information extracted from said wireless device.

13. The method of claim 8, comprising:
automatically terminating at least one service of the location-based virtual social network upon expiration of the forward time slot.

14. The method of claim 8, comprising:
sending a location-based advertisement to one or more wireless devices that joined the location-based virtual social network.

15. A system for dynamic creation of location-based virtual social networks, the system comprising:
one or more detectors to detect presence of a wireless device at a location which is associated with a location-based virtual social network; and
an invitation module to send to the wireless device an invitation to join said location-based virtual social network.

16. The system of claim 15, wherein the invitation module is to receive from the wireless device a signal indicating acceptance of the invitation and an identifier of a user of the wireless device; and wherein the system comprises a virtual community generator to add the identifier of the user of the wireless device to a list of one or more participants of the location-based virtual social network.

17. The system of claim 16, wherein the one or more detectors are to detect departure of the wireless device from said location; wherein the virtual community generator is to disassociate the wireless device from the location-based virtual social network, and to remove the identifier of the user of the wireless device from the list of participants of the location-based virtual social network.

18. The system of claim 15, wherein the one or more detectors comprise one or more detection mechanisms selected from the group consisting of:
a cellular triangulation detection mechanism;
a Global Positioning System trilateration detection mechanism;
a Radio Frequency ID detection mechanism;
a Bluetooth wireless signal detection mechanism;
an IEEE 802.11 wireless signal detection mechanism; and
an IEEE 802.16 wireless signal detection mechanism.

19. The system of claim 15, wherein the one or more detectors are to detect that two or more wireless devices are located within two or more locations of a common type; and wherein the invitation module is to send to at least one of the one or more wireless devices an invitation to join a location-based virtual social network associated with said location type.

20. The system of claim 15, wherein the virtual community generator is to send a location-based advertisement to one or more wireless devices that joined the location-based virtual social network.

21. A system for plan-based creation of virtual social networks, the method comprising:
a registration module to receive from a wireless device an indication that a user of the wireless device plans to be within a pre-defined location at a forward time slot; and
an invitation module to send to the user of the wireless device an invitation to join a location-based virtual social network associated with said pre-defined location.

22. The system of claim 21, wherein the invitation module is to send the invitation during the forward time slot upon detection that the wireless device is located within the pre-defined location.

23. The system of claim 21, wherein the registration module is to receive from the wireless device a registration message indicating that the user of the wireless device plans to be within the pre-defined location at the forward time slot.

24. The system of claim 21, wherein the registration module is to automatically extract from a scheduling application of the wireless device information indicating the pre-defined location and information indicating the forward time slot.

25. The system of claim 24, wherein the registration module is to automatically extract location and time information from another scheduling application associated with a device of another user; and wherein the system comprises a matching module to match between the location and time information extracted from the other scheduling application and the location and time information extracted from said wireless device.
